(19) United States
(12) Patent Application Publication
(10) Pub. No.: US 2013/0014106 A1
(43) Pub. Date: Jan. 10, 2013

(54) INFORMATION PROCESSING APPARATUS, COMPUTER-READABLE MEDIUM STORING INFORMATION PROCESSING PROGRAM, AND MANAGEMENT METHOD

(75) Inventors: Yuji IMAI, Kawasaki (JP); Shunsuke Kikuchi, Kawasaki (JP)

(73) Assignee: FUJITSU LIMITED, Kawasaki-shi (JP)

(21) Appl. No.: 13/531,640

(22) Filed: Jun. 25, 2012

(30) Foreign Application Priority Data
Jul. 5, 2011 (JP) 2011-149123

(51) Int. Cl. G06F 9/455

(52) U.S. Cl. 718/1

(57) ABSTRACT

A storage unit stores a correspondence between information indicating one or more services executable on one or more virtual machines and information indicating one or more users who use the services, and one or more communication monitoring rules to be used by one or more virtual routers. The rules are defined for each of the services. A control unit specifies, when a rule stored in the storing unit is changed, one or more of the users who use a service corresponding to the changed rule by referring to the storing unit. The control unit transmits the changed rule to one or more of the virtual routers which relay communication of one or more of the virtual machines assigned to the specified users so as to cause the one or more of the virtual routers, to which the changed rule is transmitted, to perform monitoring based on the changed rule.

### CROSS-REFERENCE TO RELATED APPLICATION

This application is based upon and claims the benefit of priority of the prior Japanese Patent Application No. 2011-149123, filed on Jul. 5, 2011, the entire contents of which are incorporated herein by reference.

### FIELD

The embodiments discussed herein are related to an information processing apparatus, a computer-readable medium storing an information processing program, and a management method, all of which support operational management of virtual machines.

### BACKGROUND

Virtualization technologies for operating multiple virtual computers (sometimes called virtual machines or logic hosts) on a physical computer (sometimes called a physical machine or a physical host) are currently used in the information processing field. Software such as an operating system (OS) can be executed on each of the virtual machines. A physical machine using virtualization technologies executes software for managing multiple virtual machines.

For example, software called a hypervisor allocates, as operational resources, processing power of a central processing unit (CPU) or a storage area of a random access memory (RAM) to multiple virtual machines. In addition, for example, a hypervisor may implement a network routing function on a physical machine using the operational resources. Such a routing function implemented on a physical machine may be called a virtual router. A network of virtual machines can be established on a physical machine by causing a virtual router to relay communication of the virtual machines. There are information processing systems in which virtual machines are operated on a physical machine to thereby make software on the virtual machines available to client apparatuses.

It is sometimes the case that confidential information (for example, personal information and trade secrets) is handled in information processing systems. Therefore, there is a demand for appropriate protective measures to prevent, for example, fraudulent acquisition and falsification of confidential information. In view of the demand, a firewall, an intrusion detection system (IDS), or an intrusion prevention system (IPS) may be provided in a network path. A firewall filters network traffic using a filter rule to thereby block communication other than communication through permitted paths and communication defined by a protocol. An IDS detects unauthorized access to an information processing system by cross-checking communication data acquired from the network with a preliminarily registered rule for detecting unauthorized (or authorized) communication. An IPS detects and, then, blocks unauthorized access. For example, a proposed technique is related to a communication system having a subscriber side apparatus and a station side apparatus for accommodating the subscriber side apparatus. In the communication system, when detecting unauthorized traffics, the station side apparatus transmits, to the subscriber side apparatus, filtering setting information with respect to a logical link for which unauthorized traffics have been detected. The subscriber side apparatus performs filtering of the logical link based on the filtering setting information. In addition, a technique is proposed in which, when detecting unauthorized access, an IDS server transmits information regarding the unauthorized access to a firewall, then the firewall generates a filtering rule based on the information, and a traffic filtering process is performed based on the generated filtering rule.
Japanese Laid-open Patent Publication No. 2008-211637
Japanese Laid-open Patent Publication No. 2008-11008

For an information processing system where software on virtual machines is available to client apparatuses, it is desirable that communication security measures be taken for each of the virtual machines. However, multiple virtual machines may be operating on multiple physical machines. In such a case, it becomes a problem that how to easily set a communication monitoring rule for each of the virtual machines. For example, if a system administrator has to set such a rule with respect to each of the multiple virtual machines or each of the physical machines, setting workload is placed on the system administrator.

### SUMMARY

In one aspect of the embodiments, there is provided an information processing apparatus for communicating with one or more different information processing apparatuses in which one or more virtual machines and one or more virtual routers for relaying communication of a corresponding one or more of the virtual machines are operable. The information processing apparatus includes a memory and one or more processors. The memory is configured to store a correspondence between information indicating one or more services executable on the virtual machines and information indicating one or more users who use the services. The memory is configured to also store one or more communication monitoring rules to be used by the virtual routers. The communication monitoring rules are defined for each of the services. The processors are configured to perform a procedure processing including specifying, when one of the communication monitoring rules is changed, one or more of the users who use one of the services which corresponds to the changed communication monitoring rule; and transmitting the changed communication monitoring rule to one or more of the virtual routers which relay communication of one or more of the virtual machines assigned to the specified users so as to cause the one or more of the virtual routers, to which the changed communication monitoring rule is transmitted, to perform monitoring based on the changed communication monitoring rule.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an information processing system according to a second embodiment;

FIG. 3 illustrates an example of hardware of a control apparatus;

FIG. 4 is a block diagram illustrating functions of individual apparatuses;

FIG. 5 is a block diagram illustrating functions of a virtual router;

FIG. 6 illustrates an example of data configuration of a connection list table;

FIG. 7 illustrates an example of data configuration of filter template tables;

FIG. 8 illustrates an example of data configuration of IDS rule template tables;

FIG. 9 illustrates an example of data configuration of a filter table;

FIG. 10 illustrates an example of data configuration of an IDS rule table;

FIG. 11 is a flowchart illustrating processing at the time of start-up of a virtual machine;

FIG. 12 is a sequence diagram illustrating the processing at the time of start-up of the virtual machine;

FIG. 13 is a flowchart illustrating processing at the time of detecting unauthorized access; and

FIG. 14 is a sequence diagram illustrating the processing at the time of detecting the unauthorized access.

### DESCRIPTION OF EMBODIMENTS

Several embodiments will be described below with reference to the accompanying drawings, wherein like reference numerals refer to like elements throughout.

### [a] First Embodiment

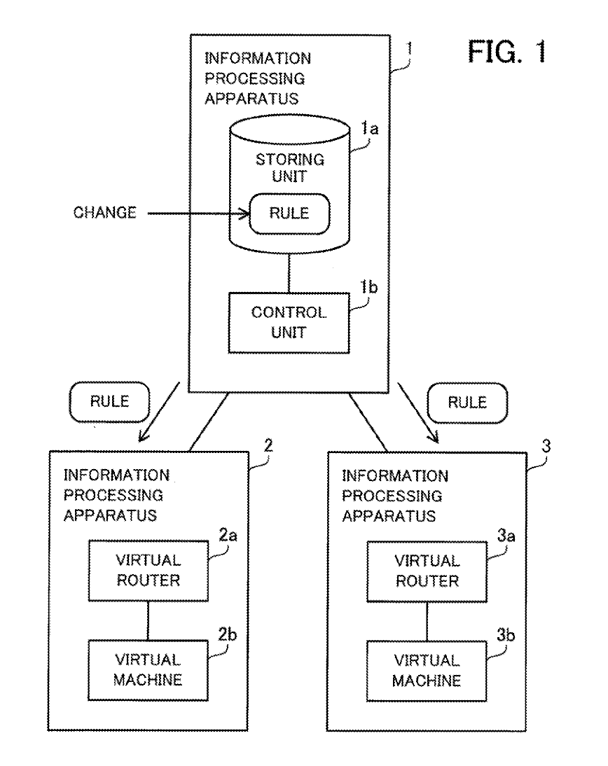

FIG. 1 illustrates an information processing system according to a first embodiment. The information processing system includes information processing apparatuses 1, 2, and 3. The information processing apparatus 1 is connected to the information processing apparatuses 2 and 3 by a network to perform data communication. The information processing apparatus 2 implements a virtual router 2a and a virtual machine 2b. The information processing apparatus 3 implements a virtual router 3a and a virtual machine 3b. The virtual routers 2a and 3a relay communication of the virtual machines 2b and 3b, respectively.

The information processing apparatus 1 includes a storing unit 1a and a control unit 1b. The storing unit 1a stores a correspondence between information indicating services executable on the virtual machines 2b and 3b and information indicating users that use the services. The storing unit 1a stores rules for communication monitoring to be performed by the virtual routers 2a and 3a, and the communication monitoring rules are defined with respect to the individual services. Such a communication monitoring rule is, for example, a rule for filtering communication. In addition, the communication monitoring rule may be, for example, pattern information (hereinafter referred to as “IDS rule”) for detecting and blocking unauthorized access. The storing unit 1a may be implemented as a RAM or a hard disk drive (HDD). When a communication monitoring rule stored in the storing unit 1a is changed, the control unit 1b determines users that use a service corresponding to the communication monitoring rule by referring to the storing unit 1a. To users, virtual machines that can be used by the users are assigned. Assume here that the virtual machine 2b is assigned to a first user and the virtual machine 3b is assigned to a second user. The control unit 1b transmits the changed rule to the virtual routers 2a and 3a which relay communication of the virtual machines 2b and 3b, respectively, assigned to the specific users to thereby cause the virtual routers 2a and 3a to perform monitoring based on the changed rule. The control unit 1b may be implemented as a program which is executed using a CPU and a RAM.

According to the information processing apparatus 1, when a communication monitoring rule stored in the storing unit 1a is changed, the control unit 1b refers to the storing unit 1a to determine users that use a service corresponding to the communication monitoring rule. The control unit 1b transmits the changed communication monitoring rule to the virtual routers 2a and 3a which relay communication of the virtual machines 2b and 3b, respectively, assigned to the individual users. The virtual routers 2a and 3a perform monitoring based on the changed communication monitoring rule. With this, it is possible to easily set a communication monitoring rule. Specifically, when a communication monitoring rule is changed, it is possible to collectively cause the virtual routers 2a and 3a of the users, who use a service corresponding to the communication monitoring rule, to perform monitoring based on the changed communication monitoring rule. For this reason, an operation for setting the changed communication monitoring rule does not have to be performed for each of the information processing apparatuses 2 and 3, which reduces the workload. Further, since multiple virtual routers share the changed communication monitoring rule, the risk of reducing security due to incorrect setting can be lessened compared to the case of setting individually.

In addition, for example, when unauthorized access to a service on one of the virtual machines is detected, a system administrator may operate the information processing apparatus 1 to change the communication monitoring rule. In such a case, according to the information processing apparatus 1, the changed communication monitoring rule is collectively applied to virtual routers corresponding to users who use the service. Accordingly, it is possible to make immediate response to the unauthorized access. Especially, in an information processing system that provides services by multiple virtual machines assigned to individual users, the multiple virtual machines are susceptible to unauthorized access using the same technique targeting, for example, security holes of the services. In view of this, according to the information processing apparatus 1, a communication monitoring rule is defined for each of the services, and the communication monitoring rule is collectively transmitted to virtual routers assigned to users who use the service. With this, it is possible to easily and efficiently respond to the unauthorized access.

### [b] Second Embodiment

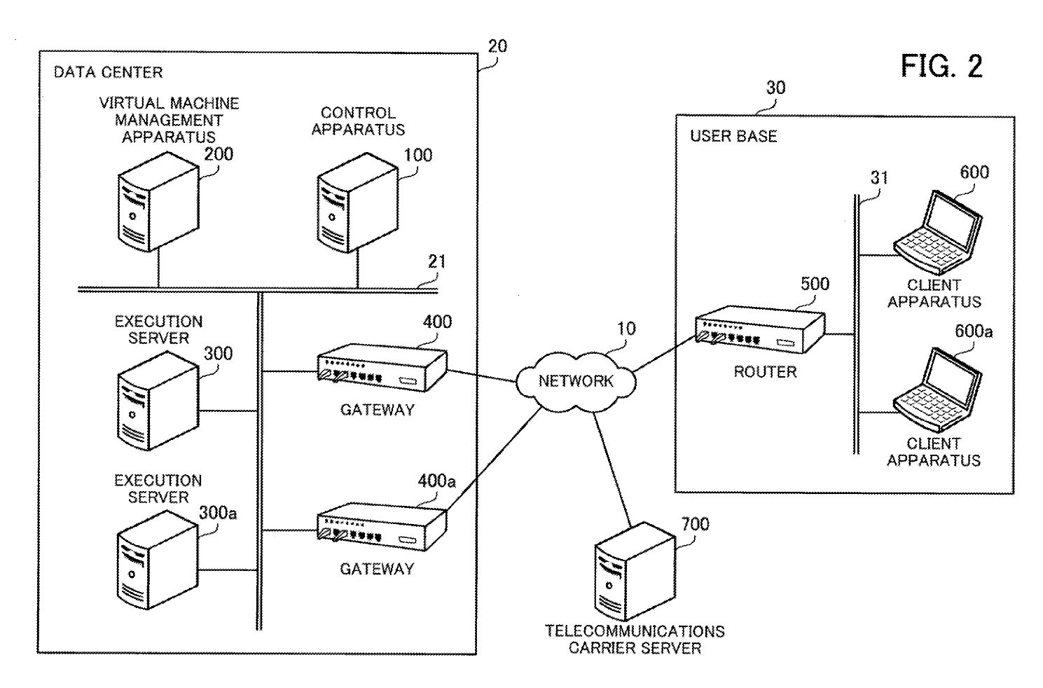

FIG. 2 illustrates an information processing system according to a second embodiment. A data center 20 is a business office operated by a service provider. A user base 30 is a business office operated by users. The service provider runs multiple virtual machines using server apparatuses of the data center 20 so that software on the virtual machines becomes available to the user base 30. Specifically, a user makes a request from a client apparatus provided in the user base 30 to software on a virtual machine to execute predetermined processing. Such a software utilization form is sometimes called as Software as a Service (SaaS).

The information processing system includes a control apparatus 100, a virtual machine management apparatus 200, execution servers 300 and 300a, gateways 400 and 400a, a router 500, client apparatuses 600 and 600a, and a telecommunications carrier server 700. The control apparatus 100, the virtual machine management apparatus 200, the execution servers 300 and 300a, and the gateways 400 and 400a are installed at the data center 20, and are individually connected to a network 21 of the data center 20. The router 500 and the client apparatuses 600 and 600a are installed at the user base 30, and are individually connected to a network 31 of the user base 30. The telecommunications carrier server 700 is installed at a business office of a telecommunications carrier (not shown), and is connected to a network 10. The network 10 is an Internet Protocol (IP) network managed by the telecommunications carrier. The network 10 is, for example, a Point to Point Protocol over Ethernet (PPPoE) network. The control apparatus 100 is an information processing apparatus which supports establishment of a tunnel connection with a Layer 2 Virtual Private Network (L2VPN) provided between virtual routers on the execution servers 300 and 300a and the router 500. This enables a VPN connection to be established via the IP network from the client apparatuses 600 and 600a to virtual machines which communicate with the virtual routers.

The virtual machine management apparatus 200 is an information processing apparatus for controlling start-up of the virtual machines and the virtual routers on the execution servers 300 and 300a. The virtual machine management apparatus 200 manages which virtual machine and virtual router are being executed on each execution server. The virtual machine management apparatus 200 manages information of virtual network interfaces (IFs) provided for each virtual router. The execution servers 300 and 300a are information processing apparatuses, each of which starts up a virtual machine and a virtual router according to a start-up instruction from the virtual machine management apparatus 200. For example, the execution servers 300 and 300a execute a hypervisor. When receiving an instruction for starting up a virtual machine and a virtual router from the virtual machine management apparatus 200, the hypervisor starts up the virtual machine and the virtual router using resources on the execution servers 300 and 300a. The gateways 400 and 400a are communication apparatuses, each of which relays communication between the network 10 and the network 21. The router 500 is a communication apparatus for relaying communication between the network 10 and the network 31. The router 500 is also provided with a function for receiving a selection of a service that a user desires to use on a virtual machine which has been assigned to the user by the service provider. The router 500 transmits a content of the selected service to the control apparatus 100 to request the service to be available on the virtual machine of the user. The client apparatuses 600 and 600a are information processing apparatuses used by users. By operating the client apparatuses 600 and 600a, the users are able to request the virtual machines on the execution servers 300 and 300a to perform processing. The users are able to use the virtual machines on the execution servers 300 and 300a from the client apparatuses 600 and 600a using, for example, a web browser, Remote Desktop Protocol (RDP), Virtual Network Computing (VNC), Secure Shell (SSH), or File Transfer Protocol (FTP).

In response to a request from the control apparatus 100, the telecommunications carrier server 700 provides information for connecting the gateways 400 and 400a and the router 500 to the network 10. For example, the telecommunications carrier server 700 transmits information such as a user identifier (ID) and a password used in PPPoE to each of the gateways 400 and 400a and the router 500. Based on the provided information, a predetermined authentication server on the network 10 performs PPPoE authentication on the gateways 400 and 400a and the router 500. If the PPPoE authentication is successful, the gateways 400 and 400a and the router 500 are connected to the network 10. In addition, the telecommunications carrier server 700 provides, for example, information for allowing an IP-VPN connection of the gateways 400 and 400a and the router 500.

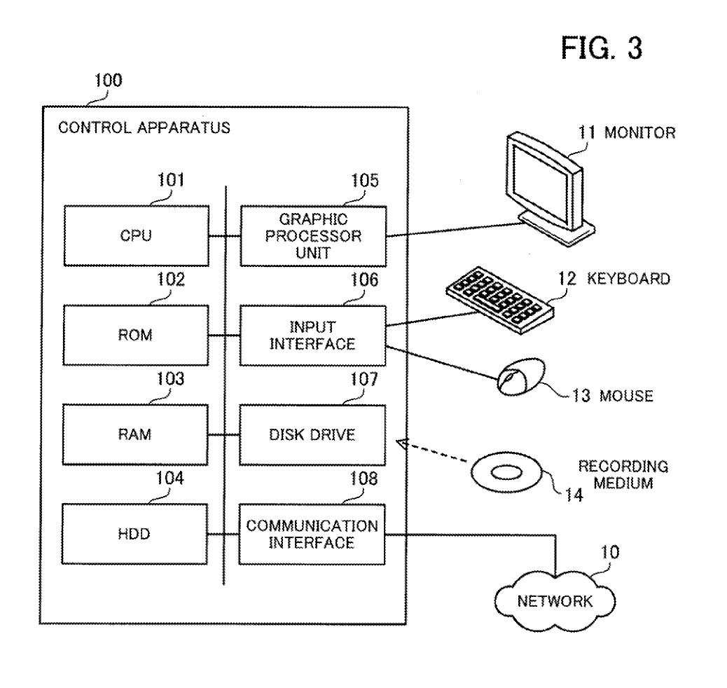

FIG. 3 illustrates an example of hardware of a control apparatus. The control apparatus 100 includes a CPU 101, a read only memory (ROM) 102, a RAM 103, a HDD 104, a graphic processor unit 105, an input interface 106, a disk drive 107, and a communication interface 108.

The CPU 101 controls the entire control apparatus 100 by executing a program of an OS or an application. The ROM 102 stores predetermined programs such as a basic input/output system (BIOS) program executed at the start-up of the control apparatus 100. The ROM 102 may be a writable nonvolatile memory. The RAM 103 temporarily stores at least part of an OS program and application programs to be executed by the CPU 101. In addition, the RAM 103 temporarily stores at least part of data to be used for processing of the CPU 101. The HDD 104 stores the OS program and application programs. In addition, the HDD 104 stores the data to be used for processing of the CPU 101. Note that, in place of the HDD 104 (or in conjunction with the HDD 104), another type of nonvolatile memory device such as a solid state drive (SSD) may be used. The graphic processor unit 105 is connected to a monitor 11. The graphic processor unit 105 causes the monitor 11 to display an image according to a command from the CPU 101. The input interface 106 is connected to input devices such as a keyboard 12 and a mouse 13. The input interface 106 outputs an input signal transmitted from an input device to the CPU 101.

The disk drive 107 is a reader for reading data stored in a recording medium 14. In the recording medium 14, for example, a program to be executed by the control apparatus 100 is stored. By performing the program stored in the recording medium 14, the control apparatus 100 is able to implement, for example, functions to be described below. That is, the program can be distributed in the form of being stored in the computer-readable recording medium 14. As the recording medium 14, for example, a magnetic recording apparatus, an optical disk, a magnetooptical recording medium, or a semiconductor memory may be used. The magnetic recording apparatus may be a HDD, a flexible disk (FD), or a magnetic tape. The optical disk may be a compact disc (CD), a CD-recordable (R), a CD-rewritable (RW), a digital versatile disc (DVD), or a DVD-R/RW/RAM. The magnetooptical recording medium may be a magneto-optical disk (MO). The semiconductor memory may be a flash memory such as a universal serial bus (USB).

The communication interface 108 is connected to the network 10. The communication interface 108 is able to perform data communication, via the network 21, with the virtual machine management apparatus 200, the execution servers 300 and 300a, and the gateways 400 and 400a. In addition, the communication interface 108 is able to perform data communication with the router 500 and the telecommunications carrier server 700 via the gateways 400 and 400a and the network 10.

Note that the virtual machine management apparatus 200, the execution servers 300 and 300a, the client apparatuses 600 and 600a, and the telecommunications carrier server 700 may be achieved using the same hardware configuration as the control apparatus 100. The following description is given with particular reference to the gateway 400 among the gateways 400 and 400a, however, the same applies to the gateway 400a.

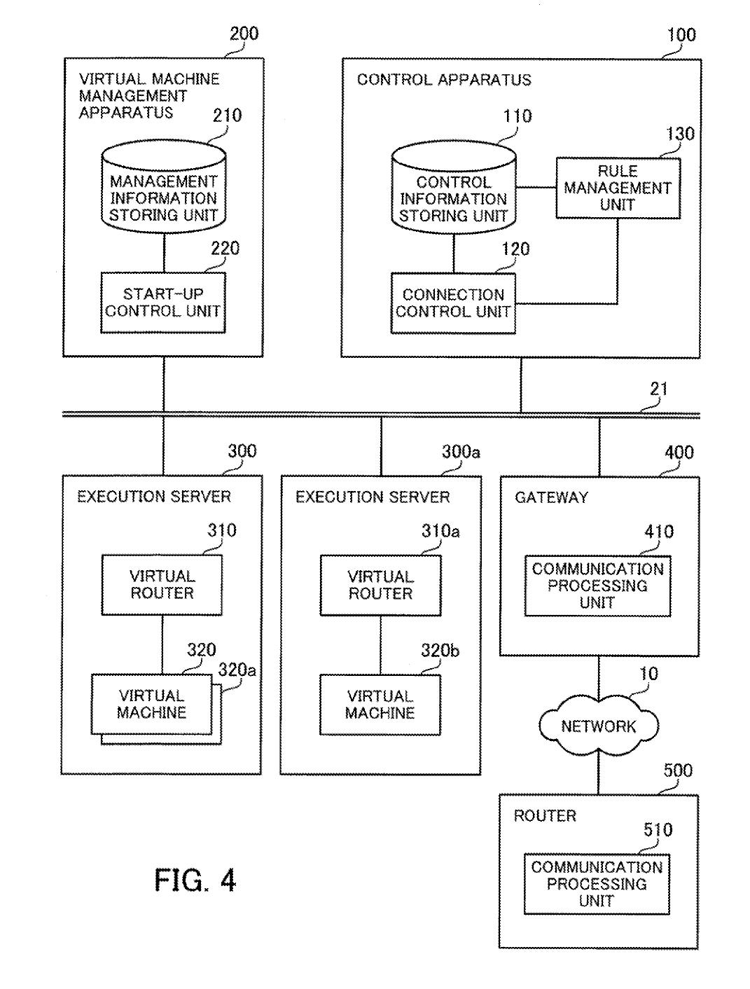

FIG. 4 is a block diagram illustrating functions of individual apparatuses. The control apparatus 100 includes a control information storing unit 110, a connection control unit 120, and a rule management unit 130. The functions of the components of the control apparatus 100 are implemented on the control apparatus 100, for example, by the CPU 101 executing a predetermined program. All or part of the functions of the components of the control apparatus 100 may be implemented using dedicated hardware.

The control information storing unit 110 stores control information. The control information includes a connection list table, a filter template table, and an IDS rule temperate table. The connection list table is data which associates identification information of users and identification information of services currently in use by the users. In the filter template table, a default filter rule is set with respect to each service. In the IDS rule template table, a default IDS rule is set with respect to each service. In the following description, the filter rule and the IDS rule may be collectively referred to as the “rules”.

In response to a request from the router 500, the connection control unit 120 instructs the virtual machine management apparatus 200 to assign the gateways 400 and 400a to the router 500. In addition, in response to a request from the router 500, the connection control unit 120 instructs the virtual machine management apparatus 200 to start up the virtual machines and the virtual routers on the execution servers 300 and 300a. Subsequently, the connection control unit 120 establishes a L2VPN connection between the virtual routers on the execution servers 300 and 300a and the router 500. Specifically, in cooperation with the telecommunications carrier server 700, the connection control unit 120 starts a PPPoE connection between the gateway 400 and the network 10. In addition, in cooperation with the telecommunications carrier server 700, the connection control unit 120 starts a PPPoE connection between the router 500 and the network 10. The connection control unit 120 connects the gateway 400 and the router 500 using an IP-VPN. In addition, the connection control unit 120 establishes an Ethernet over IP (EtherIP) tunnel between the virtual routers and the router 500. The virtual routers and the router 500 perform communication by encapsulating Ethernet (registered trademark) frames between the client apparatuses 600 and 600a and the virtual machines on the execution servers 300 and 300a using the EtherIP. The L2VPN connection enables a VPN connection between the client apparatuses 600 and 600a and the virtual machines via the network 10, which is an IP network of the telecommunications carrier. Further, the connection control unit 120 receives a content of a selected service from the router 500. The connection control unit 120 makes the selected service available on a virtual machine assigned to a user. Specifically, the connection control unit 120 instructs a start-up control unit 220 to cause the virtual machine assigned to the user to execute software for using the service (this instruction is hereinafter referred to as “service selection instruction”). In addition, the connection control unit 120 instructs the rule management unit 130 to transmit a communication monitoring rule corresponding to the service to the virtual routers.

The rule management unit 130 transmits a communication monitoring rule to the virtual routers on the execution servers 300 and 300a. Specifically, when receiving a service selection made by a user from the connection control unit 120, the rule management unit 130 transmits a rule corresponding to the service to a virtual router corresponding to a virtual machine assigned to the user. In addition, when the rule stored in the control information storing unit 110 is changed in response to an abnormal incident such as unauthorized access detected by a virtual router, the rule management unit 130 transmits the changed rule to virtual routers of users who use a service corresponding to the rule.

The virtual machine management apparatus 200 includes a management information storing unit 210 and the start-up control unit 220. Functions of the components of the virtual machine management apparatus 200 are implemented on the virtual machine management apparatus 200, for example, when a CPU provided in the virtual machine management apparatus 200 executes a predetermined program. All or part of the functions of the components of the virtual machine management apparatus 200 may be implemented using dedicated hardware. The management information storing unit 210 stores management information. The management information includes information regarding the execution servers 300 and 300a and the gateways 400 and 400a. Specifically, the management information includes information of resources available on the execution servers 300 and 300a, information indicating assignment statuses of virtual machines in execution to users, information indicating a correspondence between the virtual machines in execution and virtual routers, and information indicating virtual network IFs on individual virtual routers. In addition, the management information also includes information regarding resources available on the gateways 400 and 400a, and information indicating assignment statuses of the gateways 400 and 400a to users.

The start-up control unit 220 receives, from the connection control unit 120, an instruction to assign the gateway 400 and 400a to users. Subsequently, the start-up control unit 220 assigns the gateways 400 and 400a to the users by referring to the management information storing unit 210. The start-up control unit 220 stores the correspondence between the users and the assigned gateways in the management information storing unit 210. The start-up control unit 220 receives, from the connection control unit 120, a start-up instruction of a virtual machine corresponding to a user. Then, the start-up control unit 220 refers to the management information storing unit 210 and selects an execution server for starting up the virtual machine and a corresponding virtual router. The start-up control unit 220 causes the selected execution server to start up the virtual machine and the virtual router. The start-up control unit 220 records, in the management information storing unit 210, a correspondence among the user, the assigned execution server, the virtual machine and the virtual router. The start-up control unit 220 responds to an inquiry from the connection control unit 120 by referring to the management information storing unit 210. The start-up control unit 220 is able to respond to an inquiry about, for example, a correspondence among an execution server, a virtual machine, and a virtual router, and a correspondence between a virtual router and network IFs on the virtual router. In addition, in response to receiving a service selection instruction from the connection control unit 120, the start-up control unit 220 causes a virtual machine assigned to a target user to start execution of software that allows use of a corresponding service.

The execution server 300 includes a virtual router 310 and virtual machines 320 and 320a. Functions of the components of the execution server 300 are implemented on the execution server 300, for example, when a CPU provided in the execution server 300 executes a predetermined program. All or part of the functions of the components of the execution server 300 may be implemented using dedicated hardware. The virtual router 310 relays communication between the network 21 and the virtual machines 320 and 320a. The virtual router 310 monitors communication data to be relayed. Specifically, the virtual router 310 performs filtering based on a filter rule obtained from the rule management unit 130. In addition, the virtual router 310 detects unauthorized access based on an IDS rule obtained from the rule management unit 130. The virtual router 310 notifies the rule management unit 130 of the monitoring result. The virtual machines 320 and 320a are virtual machines implemented on the execution server 300. The virtual machines 320 and 320a individually run an OS. The virtual machines 320 and 320a may run the same OS, or may run different OSs. The virtual machines 320 and 320a individually execute software that allows use of a predetermined service. Services to be made available on the virtual machines 320 and 320a are determined by selections made by users, as described above. The execution server 300a includes a virtual router 310a and a virtual machine 320b. The virtual router 310a relays communication between the network 21 and the virtual machine 320b. In addition, the virtual router 310a monitors communication data to be relayed. The virtual machine 320b is a virtual machine implemented on the execution server 300a, and executes software that allows use of a predetermined service.

The gateway 400 includes a communication processing unit 410. The communication processing unit 410 establishes a PPPoE connection with the network 10 based on information acquired from the connection control unit 120. In addition, the communication processing unit 410 establishes an IP-VPN connection with the router 500. The router 500 includes a communication processing unit 510. The communication processing unit 510 establishes a L2VPN connection among the network 10, the gateway 400, and the virtual routers 310 and 310a based on information acquired from the connection control unit 120. In addition, the communication processing unit 510 provides, to the client apparatuses 600 and 600a, interfaces for allowing users to select services to be provided by the service provider. The communication processing unit 510 transmits contents of the selected services to the control apparatus 100.

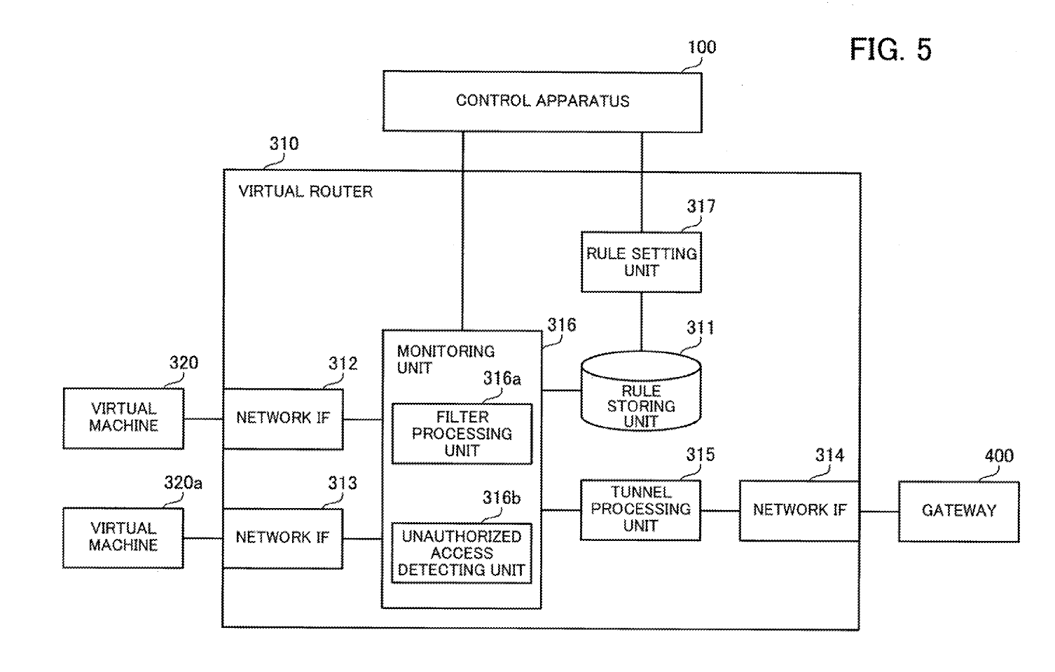

FIG. 5 is a block diagram illustrating functions of a virtual router. The virtual router 310 includes a rule storing unit 311, network IFs 312, 313, and 314, a tunnel processing unit 315, a monitoring unit 316, and a rule setting unit 317. The rule storing unit 311 stores communication monitoring rules received from the control apparatus 100. The network IFs 312, 313, and 314 are virtual network IFs which are implemented on the virtual router 310. The network IF 312 communicates with the virtual machine 320. The network IF 313 communicates with the virtual machine 320a. A network encompassing the network IFs 312 and 313 and the virtual machine 320 and 320a may be referred to as a virtual machine-side network. The network IF 314 communicates with the gateway 400 via the network 21. A network encompassing the network IF 314, the gateway 400, and the user base 30 may be referred to as a user-side network. The tunnel processing unit 315 terminates the EtherIP tunnel. Specifically, when acquiring communication data encapsulated in EtherIP from the network IF 314, the tunnel processing unit 315 takes an Ethernet frame from the communication data and outputs the Ethernet frame to the monitoring unit 316. In addition, the tunnel processing unit 315 encapsulates, with EtherIP, an Ethernet frame acquired from the monitoring unit 316, and outputs the encapsulated Ethernet frame to the network IF 314.

The monitoring unit 316 monitors Ethernet frames and limits communication between the user-side network and the virtual machine-side network. The monitoring unit 316 includes a filter processing unit 316a and an unauthorized access detecting unit 316b. The filter processing unit 316a performs filtering of information regarding a destination and a source, a port number and the like, based on a filter rule stored in the rule storing unit 311. The unauthorized access detecting unit 316b detects unauthorized access made to the virtual machine 320 or 320a based on the IDS rule stored in the rule storing unit 311. When detecting unauthorized access, the unauthorized access detecting unit 316b notifies the control apparatus 100 of the detection of the unauthorized access together with information indicating a virtual machine to which an attempt of unauthorized access was made, port information, and information regarding a communication source and destination. The rule setting unit 317 receives a communication monitoring rule from the control apparatus 100 and stores the communication monitoring rule in the rule storing unit 311. In the case where an existing rule is stored in the rule storing unit 311, the rule setting unit 317 updates the existing rule with the newly received rule. Each of the monitoring unit 316 and the rule setting unit 317 includes a dedicated virtual network IF, and communicates with the network 21 and the control apparatus 100 using the virtual network IF. Note however that the monitoring unit 316 and the rule setting unit 317 may communicate with the control apparatus 100 via the network IF 314. Note that the virtual router 310a may be achieved using the same function structure as the virtual router 310.

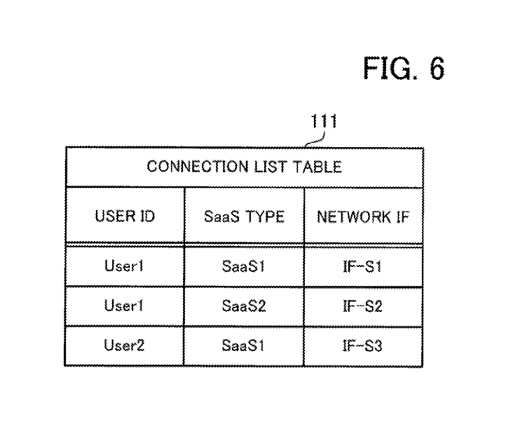

FIG. 6 illustrates an example of data configuration of a connection list table. A connection list table 111 is stored in the control information storing unit 110. In the connection list table 111, items indicating user ID, SaaS type, and network IF are provided. Information of the items in each row is associated with each other, and forms one information record for a user. In the user ID item, user IDs are set. Each user ID is information for identifying a provider which operates a user base. In the SaaS type item, identification information indicating services is set. In the network IF item, identification information of virtual machine-side network IFs on the virtual routers 310 and 310a is set.

Assume here that a user ID of a provider which operates the user base 30 is “User1”, and a user ID of a provider which operates another user base is “User2”. In addition, assume that a SaaS type of a service available on the virtual machine 320 is “SaaS1”, a SaaS type of a service available on the virtual machine 320a is “SaaS2”, and a SaaS type of a service available on the virtual machine 320b is “SaaS1”. Further, assume that identification information of the network IF 312 is “IF-S1”, identification information of the network IF 313 is “IF-S2”, and identification information of one of the virtual machine-side network IFs of the virtual router 310a is “IF-S3”. For example, identification information of each of the network IFs 311, 312, and 313 may be an IP address on a network to which the network IF belongs.

In the connection list table 111, an information record in which the user ID is “User1”, the SaaS type is “SaaS1”, and the network IF is “IF-S1” is set, for example. This information indicates that the provider (“User1”) operating the user base 30 uses a service whose SaaS type is “SaaS1”. The information also indicates that, in order to use the service, communication is performed via the network IF 312 (“IF-S1”) on the virtual router 310. In addition, in the connection list table 111, an information record in which the user ID is “User1”, the SaaS type is “SaaS2”, and the network IF is “IF-S2” is set, for example. This information indicates that the provider (“User1”) operating the user base 30 uses a service whose SaaS type is “SaaS2”. The information also indicates that, in order to use the service, communication is performed via the network IF 313 (“IF-S2”) on the virtual router 310. In addition, in the connection list table 111, an information record in which the user ID is “User2”, the SaaS type is “SaaS1”, and the network IF is “IF-S3” is set, for example. This information indicates that the provider (“User2”) operating another user base uses a service whose SaaS type is “SaaS1”. The information also indicates that, in order to use the service, communication is performed via the network IF “IF-S3” on the virtual router 310a.

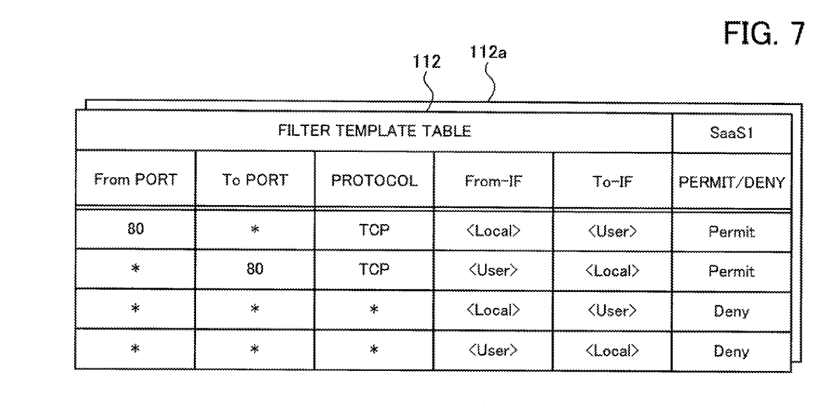

FIG. 7 illustrates an example of data configuration of filter template tables. Filer template tables 112 and 112a are generated with respect to individual SaaS types and stored in the control information storing unit 110. The filter temperate table 112 is a template of a filter rule for the SaaS type “SaaS1”. The filter temperate table 112a is a template of a filter rule for the SaaS type “SaaS2”. Next described is the filter template table 112. The filter template table 112a has the same data configuration as the filter template table 112. The filter template table 112 includes items of From port, To port, protocol, From-IF, To-IF, and permit/deny. Information of the items in each row is associated with each other, and forms one filter rule template. In the From port item, port numbers of sources are set. In the To port item, port numbers of destinations are set. In the protocol item, protocol types are set. In the From-IF item, identification information of network IFs is set, each of which is connected to a user-side network. In the To-IF item, identification information of network IFs is set, each of which is connected to a virtual machine-side network. In the permit/deny item, information indicating whether to permit or deny communication is set.

For example, the following information is set in the filter template table 112: “80” in the From port item, “*” in the To port, “TCP (Transmission Control Protocol)” in the protocol item, “<Local>” in the From-IF item, “<User>” in the To-IF item, and “Permit” in the permit/deny item. This information indicates permitting communication from the virtual machine-side network to the user-side network according to TCP (communication in Hypertext Transfer Protocol (HTTP)) at a port number “80”. In addition, for example, the following information is also set in the filter template table 112: “*” in the From port item, “80” in the To port, “TCP” in the protocol item, “<User>” in the From-IF item, “<Local>” in the To-IF item, and “Permit” in the permit/deny item. This information indicates permitting communication from the user-side network to the virtual machine-side network according to TCP (communication in HTTP) at the port number “80”. In addition, for example, the following information is also set in the filter template table 112: “*” in the From port item, “*” in the To port, “*” in the protocol item, “<Local>” in the From-IF item, “<User>” in the To-IF item, and “Deny” in the permit/deny item. This information indicates inhibiting all communication from the virtual machine-side network to the user-side network. In addition, for example, the following information is also set in the filter template table 112: “*” in the From port item, “*” in the To port, “*” in the protocol item, “<User>” in the From-IF item, “<Local>” in the To-IF item, and “Deny” in the permit/deny item. This information indicates inhibiting all communication from the user-side network to the virtual machine-side network.

If a rule is located higher in the filter template table 112, a higher priority is placed on the rule. That is, according to the filter template table 112, communication in HTTP is permitted bi-directionally between the user-side network and the virtual machine-side network, however, any other communication is blocked. When acquiring the filter template table 112, a virtual router applies, to the filter template table 112, identification information of network IFs provided in the virtual router. Specifically, to “<Local>”, identification information of a network IF connected to a virtual machine on which a service of the SaaS type in question (i.e., “SaaS1”) is available is applied. To “<User>”, identification information of a network IF connected to the user-side network is applied.

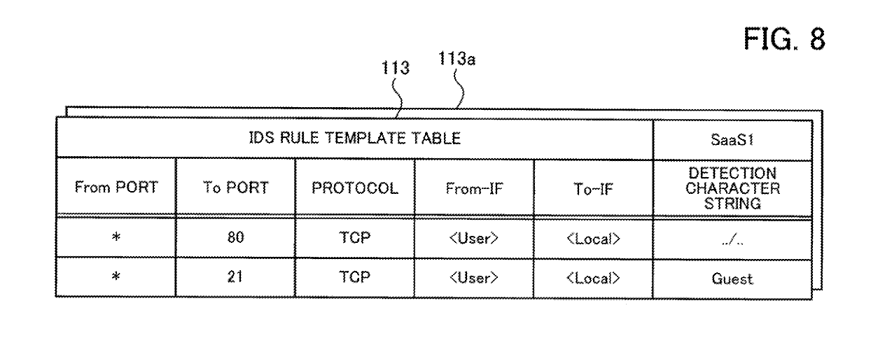

FIG. 8 illustrates an example of data configuration of IDS rule template tables. IDS rule template tables 113 and 113a are generated with respect to individual SaaS types and stored in the control information storing unit 110. The IDS rule template table 113 is an IDS rule template for the SaaS type “SaaS1”. The IDS rule template table 113a is an IDS rule template for the SaaS type “SaaS2”. Next described is the IDS rule template table 113. The IDS rule template table 113a has the same data configuration as the IDS rule template table 113.

The IDS rule template table 113 includes items of From port, To port, protocol, From-IF, To-IF, and detection character string. Information of the items in each row is associated with each other, and forms one IDS rule template. Here, contents of the individual items of From port, To port, protocol, From-IF, and To-IF are the same as those of the items of the same names in the filter template table 112 described in FIG. 7. In the detection character string item, character strings to be detection targets are set.

For example, the following information is set in the IDS rule template table 113: “*” in the From port item, “80” in the To port, “TCP” in the protocol item, “<User>” in the From-IF item, “<Local>” in the To-IF item, and “ . . . / . . . ” in the detection character string item. This information indicates that an abnormality is to be detected in the case where the character string “ . . . / . . . ” is included in communication data from the user-side network to the virtual machine-side network according to TCP at the port number “80”. When acquiring the IDS rule template table 113, a virtual router applies, to the IDS rule template table 113, identification information of network IFs provided in the virtual router. Specifically, to “<Local>”, identification information of a network IF connected to a virtual machine on which a service of the SaaS type in question (i.e., “SaaS1”) is available is applied. To “<User>”, identification information of a network IF connected to the user-side network is applied.

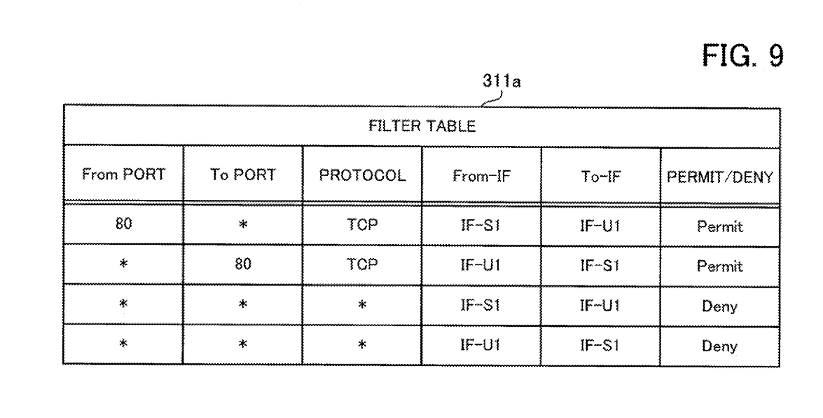

FIG. 9 illustrates an example of data configuration of a filter table. A filter table 311a is stored in the rule storing unit 311. The filter table 311a exemplifies a case in which the filer template table 112 is applied to the virtual router 310. The filter table 311a includes items of From port, To port, protocol, From-IF, To-IF, and permit/deny. Information of the items in each row is associated with each other, and forms one filter rule. Here, a content of each item is the same as that of the item in the filter template table 112 described in FIG. 7. Compared to the filter template table 112 and the filter table 311a, contents set in the From-IF and To-IF items are different. “<Local>” in the filter template table 112 is replaced, in the filter table 311a, with the identification information (“IF-S1”) of the network IF 312 connected to the virtual machine 320. In addition, “<User>” in the filter template table 112 is replaced, in the filter table 311a, with the identification information (“IF-U1”) of the network IF 314. The filter processing unit 316a performs filtering by referring to the filter table 311a.

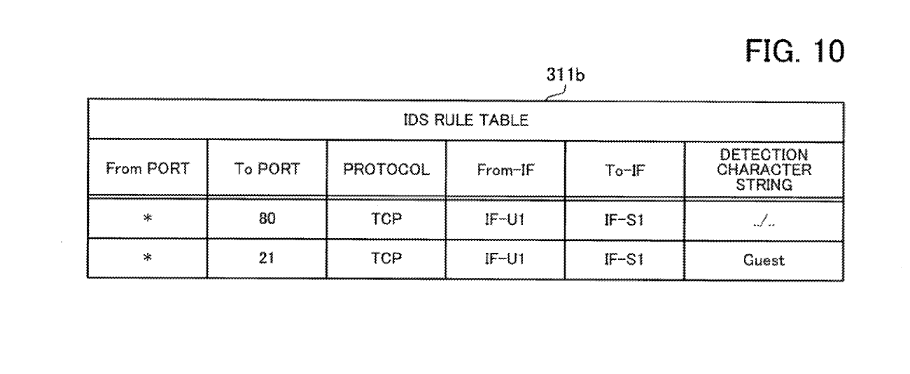

FIG. 10 illustrates an example of data configuration of an IDS rule table. The IDS rule table 311b is stored in the rule storing unit 311. The IDS rule table 311b exemplifies a case in which the IDS rule template table 113 is applied to the virtual router 310. The IDS rule table 311b includes items of From port, To port, protocol, From-IF, To-IF, and detection character string. Information of the items in each row is associated with each other, and forms one IDS rule. Here, contents of the individual items of From port, To port, protocol, From-IF, To-IF, and detection character string are the same as those of the items of the same names in the IDS rule template table 113 described in FIG. 8. Compared to the IDS rule template table 113 and the IDS rule table 311b, contents set in the From-IF and To-IF items are different. “Local” in the IDS rule template table 113 is replaced, in the IDS rule table 311b, with the identification information (“IF-S1”) of the network IF 312 connected to the virtual machine 320. In addition, “User” in the IDS rule template table 113 is replaced, in the IDS rule table 311b, with the identification information (“IF-U1”) of the network IF 314. The unauthorized access detecting unit 316b performs detection of unauthorized access by referring to the IDS rule table 311b.

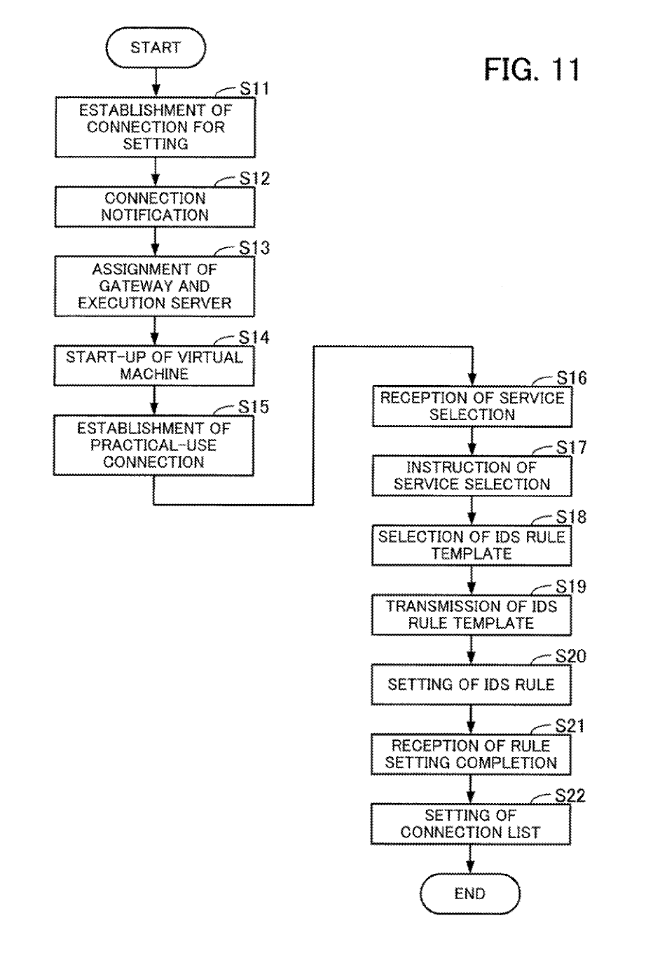

Next described is an operating procedure of the information processing system having the above-described structure. FIG. 11 is a flowchart illustrating processing at the time of start-up of a virtual machine. The processing of FIG. 11 is described next according to the step numbers.

[Step S11] When the router 500 is physically connected to the network 10 (for example, a Wide Area Network (WAN) port is connected with a network line), the communication processing unit 510 establishes a connection with the network 10 based on predetermined connection information. Further, the communication processing unit 510 establishes an IP-VPN connection with the gateway 400 for an initial setting based on the predetermined connection information. The predetermined connection information includes, for example, an ID and a password to establish a PPPoE connection with the network 10 and information of an IP-VPN group, and is recorded in a memory provided in the router 500 at the time of, for example, factory shipment of the router 500. Note that the gateway 400 always establishes at least one PPPoE connection with the network 10 for an initial setting.

[Step S12] The communication processing unit 510 issues a connection notification to the control apparatus 100. The connection notification includes information of a virtual machine to be started up (for example, an OS type, performance of a CPU, information specifying a memory capacity and a HDD capacity) and identification information of a user. The information of the virtual machine is recorded in a memory provided in the router 500 at the time of, for example, factory shipment of the router 500. For the connection notification, a request in HTTP is used, for example. Specifically, using an HTTP PUT request which specifies a Uniform Resource Locator (URL) of the control apparatus 100, the communication processing unit 510 issues a connection notification including information of the virtual machine to be started up. The connection control unit 120 receives the connection notification from the router 500. For example, the connection control unit 120 has a Web server function and receives the connection notification, which is transmitted as an HTTP request by the router 500.

[Step S13] The connection control unit 120 requests the start-up control unit 220 to assign a gateway to be used for establishing a connection for a practical use. In addition, the connection control unit 120 requests the start-up control unit 220 to assign an execution server which meets requirements of the virtual machine specified in the connection notification. The start-up control unit 220 assigns a gateway and an execution server to the user with reference to the management information storing unit 210. Assume that the start-up control unit 220 assigns, for example, the gateway 400 and the execution server 300 to the user. The connection control unit 120 establishes an IP-VPN connection between the gateway 400 and the router 500.

[Step S14] The start-up control unit 220 causes the execution server 300 to start up the virtual machine 320 and the virtual router 310 which is used for relaying communication with the virtual machine 320. When confirming with the execution server 300 that the start-up of the virtual router 310 and the virtual machine 320 is completed, the start-up control unit 220 notifies the connection control unit 120 accordingly. Here, the started virtual router 310 and virtual machine 320 are assigned to the user.

[Step S15] The connection control unit 120 establishes a L2VPN connection between the virtual router 310 started up in Step S14 and the router 500. After establishing the L2VPN connection, the connection control unit 120 causes the initial setting IP-VPN connection between the gateway 400 and the router 500 to be cut off. In addition, the connection control nit 120 causes the initial setting PPPoE connection between the router 500 and the network 10 to be cut off.

[Step S16] The connection control unit 120 receives, from the router 500, a service selected by the user.

[Step S17] The connection control unit 120 notifies the start-up control unit 220 of a service selection instruction indicating to make the service selected by the user available on the virtual machine assigned to the user in Step S14. The start-up control unit 220 causes the virtual machine assigned to the user to execute software that allows use of the specified service.

[Step S18] The connection control unit 120 notifies the rule management unit 130 of identification information of the service selected by the user with respect to the virtual machine assigned to the user. The rule management unit 130 selects an IDS rule template which corresponds to a SaaS type of the service by referring to the control information storing unit 110. For example, if the SaaS type is “SaaS1”, the rule management unit 130 selects the IDS rule template table 113.

[Step S19] The rule management unit 130 transmits the IDS rule template selected for the virtual router 310 started up in Step S14. At this time, the rule management unit 130 notifies the virtual router 310 that a network IF (a setting corresponding to <Local> in the template) connected to the virtual machine 320 on which the service with the SaaS type “SaaS1” is available is the network IF 312.

[Step S20] The rule setting unit 317 converts parts of the IDS rule template which indicate destinations and sources into identification information of the network IFs 312 and 314 of the virtual router 310 to which the rule setting unit 317 belongs. Thus, the rule setting unit 317 generates an IDS rule table by the conversion, and stores the IDS rule table in the rule storing unit 311. The rule setting unit 317 notifies the control apparatus 100 of the setting completion.

[Step S21] The rule management unit 130 receives notification of the rule setting completion from the virtual router 310.

[Step S22] The connection control unit 120 updates the connection list table 111 stored in the control information storing unit 110. Specifically, the connection control unit 120 stores, in the connection list table 111, information of the SaaS type of the service available on the newly started virtual machine 320 and information of the network IFs of the virtual router 310 in association with a user ID of the user.

In the above-described manner, in response to receiving a connection notification from the router 500, the connection control unit 120 requests the virtual machine management apparatus 200 to start up the virtual router 310 and the virtual machine 320. The connection control unit 120 establishes a L2VPN connection between the router 500 and the virtual router 310. The connection control unit 120 transmits an IDS rule template to the virtual router 310. With this, a default IDS rule is set in the virtual router 310.

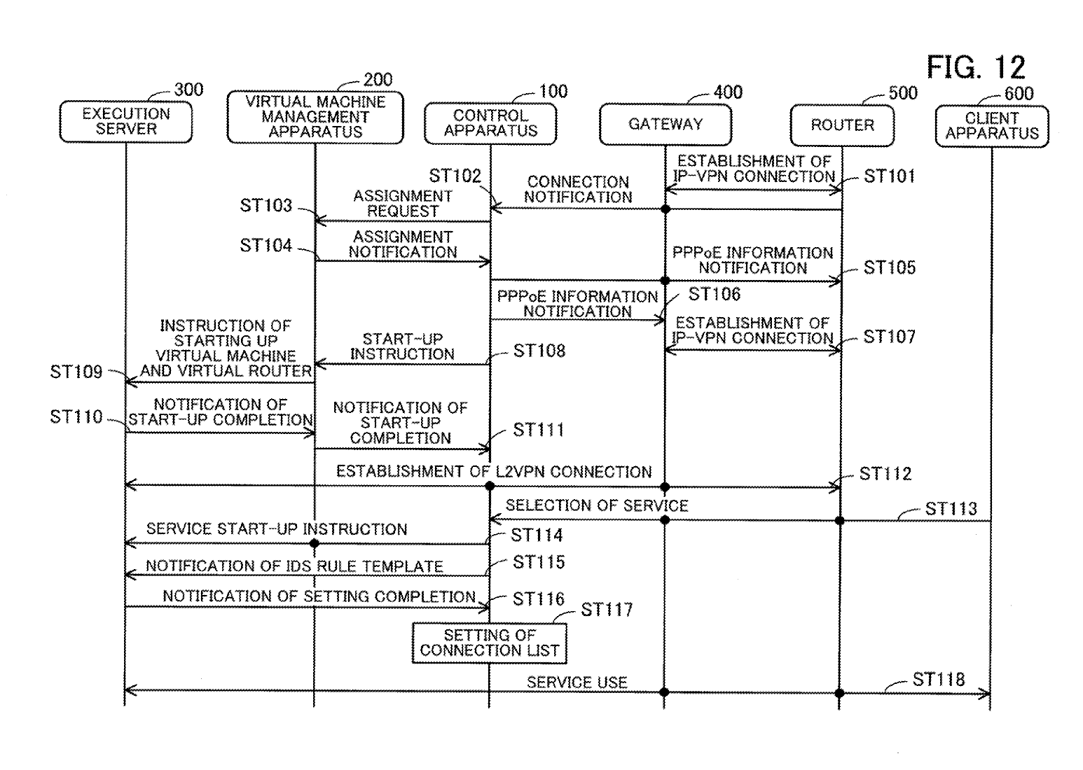

Next described is a specific example of a processing flow at the time of the start-up of a virtual machine. FIG. 12 is a sequence diagram illustrating the processing at the time of the start-up of a virtual machine. The processing of FIG. 12 is described next according to the step numbers.

[Step ST101] The router 500 connects to the network 10. Then, the router 500 performs PPPoE authentication using a predetermined ID and password to connect to a PPPoE network. In addition, the router 500 establishes an IP-VPN connection with the gateway 400 using predetermined IP-VPN group information.

[Step ST102] The router 500 transmits connection notification to the control apparatus 100. The connection notification includes information of a virtual machine to be started up and a user ID.

[Step ST103] The control apparatus 100 requests the virtual machine management apparatus 200 to assign an execution server and a gateway to a user identified by the user ID.

[Step ST104] The virtual machine management apparatus 200 assigns the execution server 300 and the gateway 400 to the user, and subsequently notifies the control apparatus 100 of the assignment result.

[Step ST105] The control apparatus 100 acquires, from the telecommunications carrier server 700, two sets of IP-VPN PPPoE connection information (an ID and a password) and IP-VPN group connection information. The control apparatus 100 transmits one of the two sets to the router 500.

[Step ST106] The control apparatus 100 transmits, to the gateway 400, the other one of the two sets of PPPoE connection information and IP-VPN group connection information acquired in Step ST105.

[Step ST107] The router 500 and the gateway 400 establish an IP-VPN connection based on the sets of PPPoE connection information and IP-VPN group information received from the control apparatus 100.

[Step ST108] The control apparatus 100 transmits, to the virtual machine management apparatus 200, an instruction of starting up a virtual machine and a virtual router.

[Step ST109] The virtual machine management apparatus 200 instructs the assigned execution server 300 to start up the virtual router 310 and the virtual machine 320.

[Step ST110] When completing the start-up of the virtual router 310 and the virtual machine 320, the execution server 300 notifies the virtual machine management apparatus 200 of the start-up completion.

[Step ST111] The virtual machine management apparatus 200 notifies the control apparatus 100 that the start-up of the virtual router 310 and the virtual machine 320 on the execution server 300 is completed.

[Step ST112] The control apparatus 100 establishes a L2VPN connection between the virtual router 310 and the router 500. Specifically, the control apparatus 100 transmits an IP address of the virtual router 310 to the router 500 to thereby cause the router 500 to configure setting for encapsulation of an Ethernet frame using the EtherIP with respect to the IP address of the virtual router 310. In addition, the control apparatus 100 transmits an IP address of the router 500 to the virtual router 310 to thereby cause the virtual router 310 to configure setting for encapsulation of an Ethernet frame using the EtherIP with respect to the IP address of the router 500. Once the L2VPN connection is established, the control apparatus 100 causes the initial setting IP-VPN connection and the initial setting PPPoE connection established in Step ST101 to be cut off.

[Step ST113] According to an interface provided by the router 500, the client apparatus 600 selects a service desired to be used on the virtual machine 320. Subsequently, the router 500 notifies a content of the selected service to the control apparatus 100 via the gateway 400.

[Step ST114] The control apparatus 100 transmits, to the virtual machine management apparatus 200, a service selection instruction to make the selected service available on the virtual machine 320. Based on the service selection instruction, the virtual machine management apparatus 200 causes the virtual machine 320 to execute software that allows use of the service (service start-up instruction).

[Step ST115] The control apparatus 100 selects an IDS rule template corresponding to a SaaS type of the selected service, and transmits the IDS rule template to the virtual router 310 which relays communication of the virtual machine 320.

[Step ST116] The virtual router 310 sets an IDS rule based on the IDS rule template, and then notifies the control apparatus 100 of the setting completion.

[Step ST117] The control apparatus 100 updates the connection list table 111 stored in the control information storing unit 110.

[Step ST118] The client apparatus 600 accesses the virtual machine 320 on the execution server 300 to be thereby able to use the selected service.

In the above-described manner, with the initial setting IP-VPN connection established between the router 500 and the gateway 400, the control apparatus 100 receives a connection notification from the router 500. The control apparatus 100 acquires, from the telecommunications carrier server 700, information for a practical use IP-VPN connection, and establishes the IP-VPN connection between the router 500 and the gateway 400. When the virtual router 310 starts up, the control apparatus 100 establishes a L2VPN connection between the virtual router 310 and the router 500. Subsequently, the control apparatus 100 causes the virtual router 310 to set a default IDS rule according to the selected service. Note that a default filter rule may be set besides the default IDS rule. In addition, the default filter rule may be configured to allow all communication.

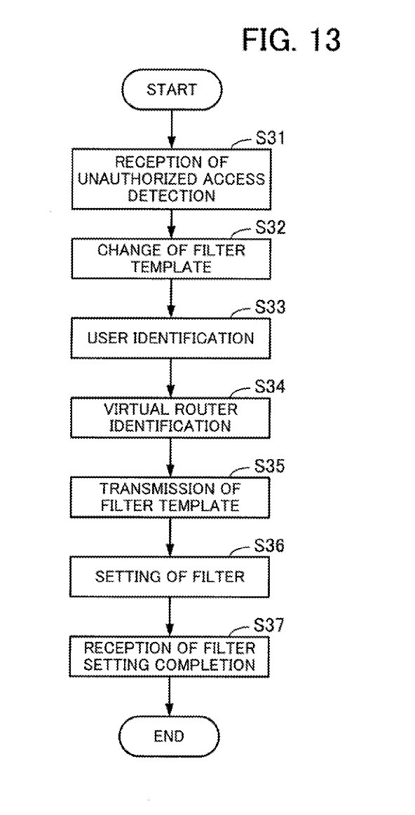

Next described is processing performed when unauthorized access to the virtual machine 320 in operation is detected. FIG. 13 is a flowchart illustrating processing at the time of detecting unauthorized access. The processing of FIG. 13 is described next according to the step numbers.

[Step S31] Based on the IDS rule stored in the rule storing unit 311, the unauthorized access detecting unit 316b detects unauthorized access to the virtual machine 320. The unauthorized access detecting unit 316b notifies the control apparatus 100 of the detection of unauthorized access to the virtual machine 320. The rule management unit 130 receives the notification.

[Step S32] The rule management unit 130 changes the filter template table 112 of the virtual machine 320. For example, the rule management unit 130 notifies a system administrator of the occurrence of the unauthorized access. Subsequently, the rule management unit 130 receives, from the system administrator, an input for instructing change or reconfiguration of the filter template table 112. The rule management unit 130 may cause the monitor 11 to display a graphical user interface (GUI) which allows the system administrator to make such an input. In addition, the rule management unit 130 may change the filter template table 112, for example, using an emergency filter rule prestored in the control information storing unit 110. In addition, after this change, the rule management unit 130 may perform filter reconfiguration described below.

[Step S33] The rule management unit 130 identifies a user ID corresponding to the SaaS type “SaaS1” of the virtual machine 320 by referring to the connection list table 111 stored in the control information storing unit 110. According to the example of the connection list table 111 of FIG. 6, “User1” and “User2” are set as user IDs corresponding to the SaaS type “SaaS1”. The rule management unit 130 identifies the user IDs “User1” and “User2”.

[Step S34] The rule management unit 130 identifies network IFs corresponding to the user IDs identified in Step S33 by referring the connection list table 111. According to the example of the connection list table 111 of FIG. 6, the rule management unit 130 identifies the network IFs “IF-S1”, “IF-S2”, and “IF-S3”. The rule management unit 130 identifies the virtual routers 310 and 310a based on identification information of the network IFs. For example, the identification information of the network IFs is IP addresses, the virtual routers 310 and 310a are identified by the IP addresses. In addition, for example, the rule management unit 130 may notify the identification information of the network IFs to the start-up control unit 220 and make an inquiry about an execution server on which a virtual router having each of the network IFs is implemented.

[Step S35] The rule management unit 130 transmits the filter template changed in Step S32 to the virtual routers 310 and 310a identified in Step S34. At this time, the rule management unit 130 notifies the virtual router 310 that a network IF (a setting corresponding to <Local> in the template) connected to the virtual machine 320 on which the service with the SaaS type “SaaS1” is available is the network IF 312. In addition, the rule management unit 130 notifies the virtual router 310a that a network IF (a setting corresponding to <Local> in the template) connected to the virtual machine 320b on which the service with the SaaS type “SaaS1” is available is the network IF “IF-S3”.

[Step S36] The rule setting unit 317 replaces “<Local>” in the filter template received from the rule management unit 130 with the identification information of the network IF 312. The rule setting unit 317 replaces “<User>” in the filter template with the identification information of the network IF 314. The rule setting unit 317 updates the existing filter table 311a stored in the rule storing unit 311 with the filter rule newly generated by the replacement. The filter processing unit 316a performs filtering using the updated filter table 311a. In a similar fashion, the virtual router 310a generates a filter rule based on the filter template transmitted by the rule management unit 130 and uses the filter rule for filtering.

[Step S37] The rule setting unit 317 notifies the rule management unit 130 of the completion of the filter setting. The rule management unit 130 receives the notification.

In the above-described manner, on the occurrence of unauthorized access to the virtual machine 320, the rule management unit 130 identifies, based on a user ID of a user who uses the virtual machine 320, the virtual machine 320b available to the user. Subsequently, the rule management unit 130 causes not only the virtual router 310 which actually detected the unauthorized access but also the virtual router 310a corresponding to the virtual machine 320b to set the changed filter rule.

Note that the above describes the case where, in Step S32, the rule management unit 130 receives change of the filter template table 112 from the system administrator, or changes the content of the filter template table 112 using a filter template prepared in advance. As another case, the rule management unit 130 may generate a new filter template based on a content of the unauthorized access. Specifically, the filter template table 112 may be changed by acquiring, from the unauthorized access detecting unit 316b, a port to which the unauthorized access was made, then generating a filter template for the port, and adding the generated filter template rule. At this point, the filter template for the port to which the unauthorized access was made may be generated with respect to bidirectional (or unidirectional) communication between the user-side network and the virtual machine-side network. For example, in the case of detecting unauthorized access to SSH (port number 22), the rule management unit 130 may generate a filter template for the port having the port number 22 in such a manner as to inhibit bidirectional (or unidirectional) communication between the user-side network and the virtual machine-side network. In addition, in Step S32, the rule management unit 130 performs change of the filter rule. However, a changing unit for performing the change may be provided separately.

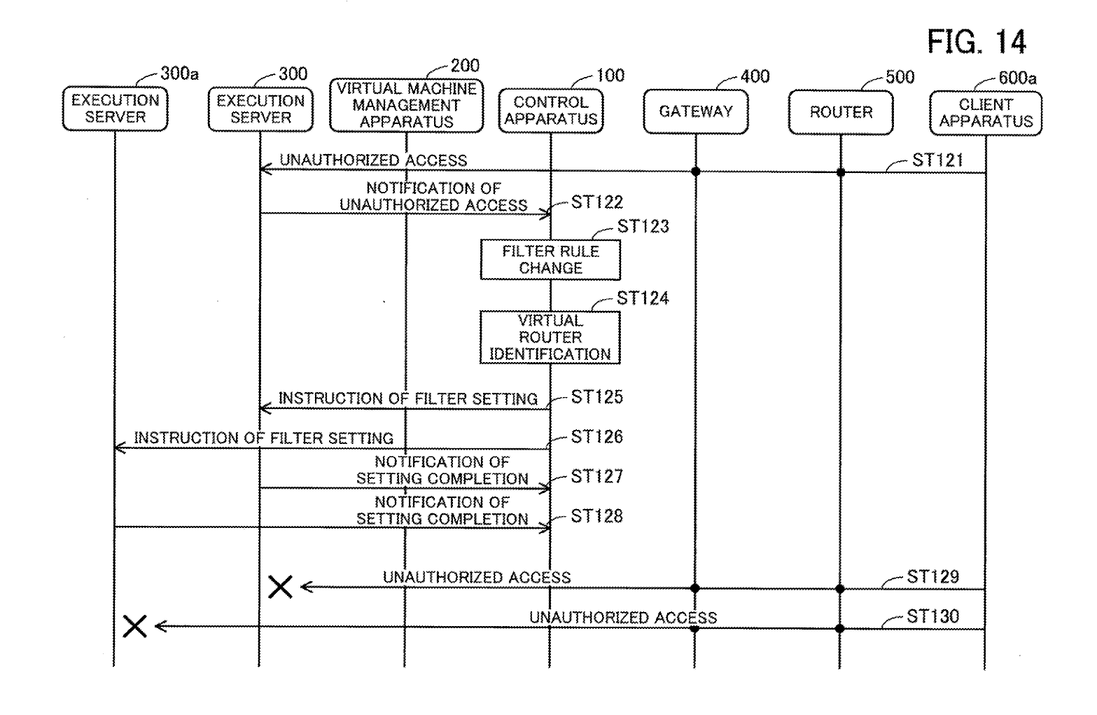

Next described is a specific example of the processing flow at the time of detecting unauthorized access. FIG. 14 is a sequence diagram illustrating the processing performed at the time of detecting unauthorized access. The processing of FIG. 14 is described next according to the step number. Assume here that just before the sequence described below, a filter is not set for a port to which unauthorized access is made, or communication to the port is allowed.

[Step ST121] The virtual router 310 detects unauthorized access from the client apparatus 600a to a predetermined port (for example, an ftp, Telnet, SSH, or VNC) of the virtual machine 320 on the execution server 300.

[Step ST122] The virtual router 310 notifies the control apparatus 100 of the detection of the unauthorized access to the virtual machine 320 (the SaaS type “SaaS1”).

[Step ST123] The control apparatus 100 changes contents set in the filter template table 112 (corresponding to the SaaS type “SaaS1”) which is stored in the control information storing unit 110. Assume here that, after the change of the filter template table 112 in Step ST123, the setting contents illustrated in FIG. 7 are obtained.

[Step ST124] The control apparatus 100 identifies the user IDs “User1” and “User2” of users who use the virtual machine 320 by referring to the connection list table 111 stored in the control information storing unit 110. The control apparatus 100 identifies the network IFs “IF-S1” and “IF-S3” corresponding to the user IDs and the SaaS type. In addition, the control apparatus 100 identifies the virtual routers 310 and 310a having the individual network IFs.

[Step ST125] The control apparatus 100 transmits the changed filter template to the virtual router 310 on the execution server 300. At this point, the control apparatus 100 notifies the virtual router 310 that a network IF connected to the virtual machine 320 on which the service with the SaaS type “SaaS1” is available is “IF-S1”. The virtual router 310 sets its own filter rule by applying information of the interface IF of the virtual router 310 to the received filter template.

[Step ST126] The control apparatus 100 transmits the changed filter template to the virtual router 310a on the execution server 300a. At this point, the control apparatus 100 notifies the virtual router 310a that a network IF connected to the virtual machine 320b on which the service with the SaaS type “SaaS1” is available is “IF-S3”. The virtual router 310a sets its own filter rule by applying information of the interface IF of the virtual router 310 to the received filter template.

[Step ST127] The virtual router 310 notifies the control apparatus 100 of the completion of the filter setting. According to the setting contents illustrated in FIG. 7, the virtual router 310 allows only HTTP communication between the user-side network and the virtual machine-side network.

[Step ST128] The virtual router 310a notifies the control apparatus 100 of the completion of the filter setting. According to the setting contents illustrated in FIG. 7, as is the case with the virtual router 310, the virtual router 310a allows only HTTP communication between the user-side network and the virtual machine-side network.

[Step ST129] The client apparatus 600a attempts unauthorized access to the virtual machine 320 on the execution server 300 using a predetermined port (such as an ftp). According to the changed filter rule, the virtual router 310 blocks the unauthorized access to the port.

[Step ST130] The client apparatus 600a attempts unauthorized access to the virtual machine 320b on the execution server 300a in the same manner as Step ST129. According to the changed filter rule, the virtual router 310a blocks the unauthorized access to a port.

In the above-described manner, the control apparatus 100 causes the virtual routers 310 and 310a to set the changed filter rule. With this, unauthorized access from the client apparatus 600a to the virtual machines 320 and 320b is blocked at the virtual routers 310 and 310a, respectively. Note that the rule management unit 130 may transmit the changed rule to individual virtual routers assigned to different users on a single execution server. In such a case, the rule management unit 130 specifies a network IF on a virtual router assigned to each of the users, which virtual router is connected to a virtual machine where the service is available, and transmits the changed rule to each of the virtual routers on the single execution server. In addition, the client apparatus 600 also accesses the virtual machines 320 and 320b via the virtual routers 310 and 310a, respectively. Therefore, even if an ill-intentioned user attempts unauthorized access to the virtual machines 320 and 320b using the client apparatus 600, the access is blocked in a similar fashion.

This enables easy setting of a communication monitoring rule for each virtual machine. Specifically, setting operation does not have to be performed for individual virtual routers, which reduces the workload. Further, since multiple virtual routers share the changed rule, the risk of reducing security due to incorrect setting can be lessened compared to the case of setting individually. In addition, this also enables easy coping with unauthorized access. Specifically, it is possible not only to take measures for a virtual machine to which unauthorized access is actually made, but also to take preliminary measures for other virtual machines likely to be subject to unauthorized access. In addition, the changed rule is collectively applied to multiple virtual machines, which enables immediate response to unauthorized access. Especially, as described in the second embodiment, in information processing systems that provide services using multiple virtual machines assigned to individual users, the multiple virtual machines are susceptible to unauthorized access using the same technique targeting, for example, security holes of the services. In view of this, according to the control apparatus 100, a communication monitoring rule is defined for each of the services, and the communication monitoring rule is collectively transmitted to virtual routers assigned to users who use the service. With this, it is possible to easily and efficiently respond to the unauthorized access.

Note that, using the setting of the filter template table 112, communication between the user-side network and the virtual machine-side network may be controlled more strictly. For example, according to the example of FIG. 7, only HTTP communication is allowed, however, the setting may be changed to inhibit all communication. Specifically, the change of the setting to cause all communication to be inhibited may be achieved by deleting, from the filter template table 112 of FIG. 7, the two records in which “Permit” is set in the permit/deny item and leaving the two records in which “Deny” is set in the permit/deny item. With this, security at the time of detecting unauthorized access can be further enhanced.

In addition, a filter rule is changed according to the second embodiment, however, an IDS rule may be changed. For example, when the IDS rule template table 113 is changed due to unauthorized access or the like, a changed IDS rule template may be transmitted to each virtual router in a sequence similar to FIG. 13. This enables easy detection of unauthorized access to each virtual machine. In addition, the unauthorized access detecting unit 316b above has an IDS function, however, may have an IPS function. In addition, the IP network managed by a telecommunications carrier is exemplified as the network 10 according to the second embodiment. However, an Internet network, for example, may be used as the network 10. In that case, the control apparatus 100 establishes a connection between a virtual router and the router 500 using an Internet VPN. For example, the control apparatus 100 is able to establish a tunnel connection between a virtual router and the router 500 using Generic Routing Encapsulation (GRE).

According to one aspect, it is possible to readily set a communication monitoring rule.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus for communicating with one or more different information processing apparatuses in which one or more virtual machines and one or more virtual routers for relaying communication of a corresponding one or more of the virtual machines are operable, the information processing apparatus comprising:
a memory configured to store
a correspondence between information indicating one or more services executable on the virtual machines and information indicating one or more users who use the services, and
one or more communication monitoring rules to be used by the virtual routers, the communication monitoring rules being defined for each of the services; and
one or more processors configured to perform a procedure including
specifying, when one of the communication monitoring rules is changed, one or more of the users who use one of the services which corresponds to the changed communication monitoring rule, and
transmitting the changed communication monitoring rule to one or more of the virtual routers which relay communication of one or more of the virtual machines assigned to the specified users so as to cause the one or more of the virtual routers, to which the changed communication monitoring rule is transmitted, to perform monitoring based on the changed communication monitoring rule.

2. The information processing apparatus according to claim 1, wherein
the procedure further includes changing a communication monitoring rule corresponding to the one of the services in response to receiving, from one of the virtual routers, notification indicating of detection of unauthorized access to one of the services, which is provided on one of the virtual machines whose communication is relayed by the one of the virtual routers.

3. The information processing apparatus according to claim 2, wherein
the changing changes the communication monitoring rule based on one or more change rules which are provided with respect to each of the services and prestored in the memory.

4. The information processing apparatus according to claim 1, wherein
the changed communication monitoring rule is for limiting predetermined communication.

5. A computer-readable, non-transitory medium encoded with a computer program which causes a computer to perform a procedure, the computer communicating with one or more information processing apparatuses in which one or more virtual machines and one or more virtual routers for relaying communication of a corresponding one or more of the virtual machines are operable, the procedure comprising:
specifying, based on a correspondence between information indicating one or more services executable on the virtual machines and information indicating one or more users who use the services, one or more of the users who use one of the services which corresponds to one of one or more communication monitoring rules to be used by the virtual routers when the communication monitoring rule is changed, the communication monitoring rules being defined for each of the services; and
transmitting the changed communication monitoring rule to one or more of the virtual routers which relay communication of one or more of the virtual machines assigned to the specified users so as to cause the one or more of the virtual routers, to which the changed communication monitoring rule is transmitted, to perform monitoring based on the changed communication monitoring rule.

6. A management method executed by an information processing apparatus which communicates with one or more different information processing apparatuses where one or more virtual machines and one or more virtual routers for relaying communication of a corresponding one or more of the virtual machines are operable, the management method comprising:
specifying, based on a correspondence between information indicating one or more services executable on the virtual machines and information indicating one or more users who use the services, one or more of the users who use one of the services which corresponds to one of one or more communication monitoring rules to be used by the virtual routers when the communication monitoring rule is changed, the communication monitoring rules being defined for each of the services, and
transmitting the changed communication monitoring rule to one or more of the virtual routers which relay communication of one or more of the virtual machines assigned to the specified users so as to cause the one or more of the virtual routers, to which the changed communication monitoring rule is transmitted, to perform monitoring based on the changed communication monitoring rule.
